(19) United States
(12) Patent Application Publication
(10) Pub. No.: US 2012/0084995 A1
(43) Pub. Date: Apr. 12, 2012

(54) Energy efficient clothes dryer

(76) Inventor: PETER SAMUEL VOGEL, FAULCONBRIDGE (AU)

(21) Appl. No.: 13/230,745

(22) Filed: Sep. 12, 2011

(30) Foreign Application Priority Data
Sep. 14, 2010 (AU) 2010904128

(51) Int. Cl. F26B 3/00; F26B 19/00; F26B 23/00; F26B 3/02

(52) U.S. Cl. 34/492; 34/282; 34/443; 34/562; 34/549

(57) ABSTRACT

A system for controlling a clothes dryer whereby the user selects a desired time of drying and the heat used to dry the clothes is adjusted during the operational time such that the clothes are not dried unnecessarily quickly. Accordingly, the energy efficiency of the clothes dryer using this invention is improved compared to the prior art.

### FIELD OF THE INVENTION

The present invention relates to drying appliances and methods of controlling them to improve energy efficiency.

### BACKGROUND OF THE INVENTION

Clothes dryers are a popular item found in many laundries. The most common type of clothes dryer uses an electric element or gas flame to heat air which is then blown through the clothes to hasten drying. Most dryers contain the clothes in a drum which tumbles the clothes to further improve speed and uniformity of drying.

Typical clothes dryers have a number of controls which allow the user to select different drying programs. The simplest control system provides a timer which operates the dryer for a certain time, during which the clothes may be insufficiently or excessively dried. Improved dryers use sensors which detect when the clothes are dried to the desired degree. For example, many dryers monitor the air outlet temperature and when a sudden rise of temperature is sensed, drying is terminated as it is assumed that the rise in temperature was due to all the water in the clothes having evaporated, that is, the clothes are dry.

Such dryers are simple and inexpensive but have certain shortcomings, most notably poor energy efficiency. A major reason for poor energy efficiency is that much of the energy consumed by these dryers is wasted in the form of hot air exiting the machine. In general, lower temperatures applied result in slower but more efficient drying as less of the energy input is wasted in the exhaust.

Some effort has been made to provide clothes dryers of improved efficiency. Using an electric heat pump instead of a resistive heating element is an effective way of reducing energy consumption, however such dryers are significantly more expensive and hence not popular.

In U.S. Pat. No. 4,226,026 Deming discloses an improved efficiency clothes dryer in which a low energy level is applied for an initial drying period, followed by a shorter period of higher energy to complete the drying cycle. This system has the advantage of using less energy for drying than a dryer which uses full energy for the whole cycle while providing the short period of high temperature required to remove wrinkles from ‘permanent press’ fabrics. While this invention provides energy savings in some circumstances, there is still a need for further flexibility and improved energy efficiency.

### SUMMARY OF THE INVENTION

It is an object of this invention to provide a reduced-energy clothes drying machine and method. Whereas prior art clothes dryers offer the operator a selection of operating durations, heating power or target dryness levels, with this invention the operator selects the desired drying time and the dryer applies the minimum amount of heating energy required to achieve the desired dryness in the desired drying time.

For example, the operator might wash a load of clothes in the morning before leaving for work, transfer the clothes to the dryer, and select a drying time of 9 hours. If it is a warm day, the controller of this invention might determine that the clothes can be dried without applying any power to the dryer's heater and simply start tumbling and blowing room temperature air through the clothes. If at some point before the 9 hours has elapsed the sensed moisture of the clothes drops to the desired level selected by the operator, the cycle is terminated. If after say 4 hours the level of moisture drop sensed suggests that the clothes will not be dry in 9 hours, the controller applies a small amount of heating power, the power level being calculated by a suitable predictive algorithm. The power level is similarly increased or decreased as the cycle progresses so that the desired dryness is attained at the target time for termination.

In another example, the time selected might be shorter or the ambient temperature lower, such that the controller of the invention might determine that air drying alone will not be sufficient. In that case power will be applied to the heater early in the cycle. By monitoring the dryness over a period, the controller can adaptively vary the heating power to ensure that the desired dryness is attained in the specified time.

The invention provides an energy-saving method of clothes drying because the drying air is maintained at the minimum air temperature required to achieve proper drying. If a higher temperature is used, more energy is wasted by being vented through the exhaust or in heating the dryer itself. The inventor has found that a dryer using this inventive concept typically uses about 20% less energy than a prior art dryness-sensing dryer to dry a given load. This saving was achieved with the invention set for a four hour cycle, whereas the prior art dryer achieved the same dryness in 1.5 hours.

According to a first aspect of the present invention, there is provided a clothes dryer control method comprising the steps of inputting from an operator a drying-time selection, estimating how much power needs to be applied to heat the air entering the dryer in order to dry the clothes within the input time, and controlling the power applied to heating according to that estimate.

The drying time can be input as a duration relative to the start time or as an absolute time of day.

According to another aspect of the invention, the estimating step of the invention includes at least one of the following sub-steps:
a) Measuring moisture content of the clothes, for example using electrical conductivity
b) Measuring change in moisture content of the clothes over time
c) Measuring the ambient temperature
d) Measuring the dryer air temperature inside the machine or at the exhaust
e) Measuring change in the dryer exhaust air temperature over time
f) Measuring the humidity within the dryer, at the air intake or at the exhaust
g) Measuring the change in humidity within the dryer, at the air intake or at the exhaust
h) Measuring the mass of the clothes in the drying chamber
i) Measuring change in the mass of the clothes in the drying chamber over time
j) Measuring vibration of the dryer or its components
k) Measuring change in vibration of the dryer or its components over time
l) Factoring into a predictive algorithm the time of day at which the drying cycle is being performed, for example as a predictor of likely ambient temperature trend
m) Factoring into a predictive algorithm the time of day at which the drying cycle is being performed so as to consume energy at the time of lowest energy cost
n) Factoring into a predictive algorithm the time of day at which the drying cycle is being performed so as to consume energy at the time of greatest energy availability, for example delaying heating until the early hours of the morning.
o) Factoring into a predictive algorithm the duration of drying selected by the operator
p) Factoring into a predictive algorithm a maximum clothing temperature selected by the operator

In some embodiments of the invention, the step of measuring moisture content is practised by measuring the absorption or reflection of acoustic or electromagnetic waves by the contents of the drying chamber. In some embodiments of the invention, the step of measuring change in moisture content is practised by measuring the change in absorption or reflection of acoustic or electromagnetic waves by the contents of the drying chamber.

According to an extension of the inventive concept, the air flow through the drying clothes is also varied according to an adaptive algorithm. For example, a higher airflow is beneficial to drying when no or little heating is being used, whereas a lower air flow is preferable when heating of the clothes is required. In some embodiments, a variable blower can be used without any heating. This is particularly effective when heat is available from another source, such as ambient heat in warm weather or a heated room, or waste heat from other equipment such as a refrigerator.

According to another aspect of the invention, the method comprises the steps of exposing wet clothes to a low temperature air flow for a first time interval followed by a higher temperature air flow for a second interval.

According to another aspect, the inventive method further comprises the step of exposing the clothes to a low temperature air flow to cool the clothes after drying.

In yet another aspect, the invention further comprises the step of reducing the air flow during the high temperature step of the method.

In yet another aspect, the inventive method also comprises the step of receiving instructions from an operator, said instructions including at least a desired maximum duration for the drying process or a desired time of day by which drying is to be completed. In some useful extensions of the invention, operator instructions also include a desired maximum drying temperature, designated in units of temperature or as bands of temperature, such as “low” or “high”.

According to another aspect, the invention further comprises the steps of referring to a schedule of energy tariffs and minimising cost of energy by scheduling the consumption of energy according to the times of day at which energy is least expensive.

The invention also comprises a clothes dryer or a controller utilising the method of this invention.

### DESCRIPTION OF PREFERRED EMBODIMENTS

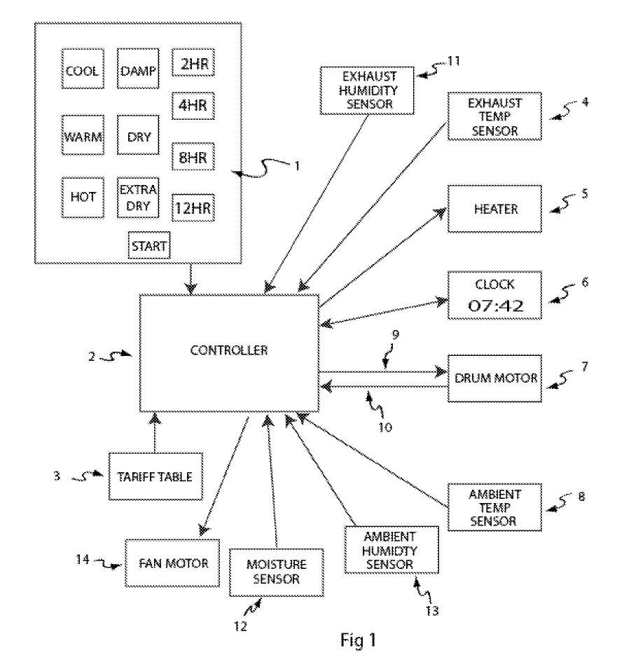

Embodiments of the invention will now be described with reference to the drawings in which FIG. 1 is a block diagram of an embodiment of the present invention.

In this embodiment, the invention is practised as an improved drum-style electric clothes dryer, or “tumble dryer”. The drawing shows only the control system of the invention in schematic form, the mechanical aspects of the invention being well known, comprising primarily a rotating drum into which clothes are loaded, a fan which blows air through the load, a heater which heats the air before it enters the drum and a motor which drives the fan directly and drives the drum via a belt.

Controller 2 is a microcontroller programmed with suitable software to carry out the steps of the invention and interfaced to certain other devices as will now be described.

When the dryer is in its idle state, the operator loads the wet clothes into the dryer and selects a desired drying time using control panel 1. In one preferred embodiment, the drying time can be nominated in terms of duration (e.g. 8 hours) or an absolute time (e.g. 19:00). Clock 6 can serve multiple purposes, such as displaying the time of day, setting/displaying the desired drying duration, or setting/displaying the target time for completion. The operator optionally also selects a dryness setting and desired maximum temperature, in this example the choices are damp, dry, or extra dry and cool, warm or hot.

Next the operator presses the START button. Controller 2 then performs a data gathering operation to acquire the information required to assess the most energy-efficient way of drying the load. Next, controller 2 performs an algorithm based on the acquired data, the result of which is a sequence of steps which is likely to result in the clothes being dried to the desired dryness, using the desired maximum temperature, in the desired time, while utilising the least possible energy.

Many different algorithms can be utilised with good results. Some exemplary algorithms will now be described.
Simple Algorithm
An exemplary simple algorithm may be chosen for simplicity of implementation and execution. The simple algorithm receives as input variables the estimated amount of water in the load (W), the target drying duration (D), moisture (M) and maximum temperature (T). According to these variables, the algorithm calculates the period energy will need to be applied to the heater (Ph) and the corresponding period of cold (Pc) based constants.
The simplified expression might be D=Ph+Pc
Ph=W*Kh (Kh is a constant representing the time taken to evaporate a given amount of water when hot, previously found by experiment)
Pc=W*Kc (Kc is a constant representing the time taken to evaporate a given amount of water when hot, previously found by experiment).
The algorithm estimates the optimum Ph and Pc to achieve minimum power consumption, that is minimum Ph that will attain the target dryness in the target time.
Improved Algorithms
Performance can be further enhanced by factoring in other variables including the ambient temperature and humidity. For example, ambient temperature and humidity can be read from sensors 8 and 13 respectively and this data can be used to estimate the least-energy process that will achieve the desired dryness in the desired time. If the temperature is high, humidity low, and time allowed long, drying could be achieved with no power applied to the heater.
Prediction by Extrapolation

Another technique which can be applied to this invention with good results is measuring the water loss of the load over a period of time under known conditions and using this data to calculate the optimum process for achieving the desired dryness in the desired time. For example, one embodiment of the invention functions as follows:
a) Operator selects target time, dryness and peak temperature.
b) Controller 2 signals drum motor 7 to start via control signal 9 and also signals fan motor 14 to start.
c) Controller 2 signals heater 5 to apply a power level calculated according to certain factors, for example ambient temperature and selected drying time. For example, if the operator has requested a long drying time of say 10 hours, and the ambient temperature is high, little or no power need be applied to heater 5 as it can be predicted that the clothes will be dried within 10 hours without extra heat. However if a shorter time were requested controller 2 may decide that some heat will be required.
d) Controller 2 inputs moisture data from moisture sensor 12 repeatedly (say every second) for a long enough time to discern a significant reduction in moisture, for example an hour. Moisture sensor 12 can employ one or more of a variety of techniques for measuring moisture of the load. One inexpensive and effective system well-known to the art uses electrical contacts which are periodically bridged by the tumbling clothes, the resistance of the conductive path presented by the clothes being a function of their dampness. Many other systems can be employed with good results. For example, adsorption of visible light, infrared light, radio or acoustic energy by the clothes can be used as a determinant of dampness. Another technique which can determine dampness or changes in dampness is to measure changes in the load on drum motor 7 as the load rotates. For this purpose controller 2 in some embodiments receives feedback from motor 7 via signal 10. Signal 10 may indicate, for example, the power factor, phase angle or load current of the motor. Alternatively, the motor may be mounted on strain or movement sensors, the output of which reflects the varying load as the drum rotates. Because the load is being cyclically lifted and dropped, the load on motor 7 fluctuates with each drum rotation, and the amplitude of the fluctuation will be a function of load weight and hence dampness. Although it is difficult to measure absolute moisture this way, it is a useful way of measuring rate of change in dampness.
e) Controller 2 calculates the rate of moisture reduction.
f) Controller 2 executes an algorithm based on the measured rate of moisture change and other inputs, to determine the optimum (least energy) drying parameters.
Tariff-Responsive
Another variation of the invention takes into account variations of electricity pricing at different times of the time of day or week, scheduling maximum energy consumption to occur at the time of lowest cost. As well as achieving lowest cost operation, this technique can also be beneficial in that the lowest cost period is generally also the time of lowest total demand on the electricity supply system, so that the most drying energy is consumed when most is available. To facilitate this aspect of the invention, tariff table 3 provides the tariff vs time data, although other techniques can be used to provide tariff or demand data, for example instantaneous pricing via an internet connection or using “smart grid” technologies.

If the requested drying time is so short that significant heating will be required, completion of drying can be detected using moisture sensor 12, alone or in combination with other sensed data. For example, a rapid decline in exhaust humidity (detected by sensor 11) or rapid increase in exhaust temperature (detected by sensor 4) can be taken into consideration as probable indicators of completion of drying.

It will be understood that while certain preferred embodiments of the invention are described above, many variations can be made without departing from the scope of the invention.

For example, whereas the invention is described as operating with electric heating, other sources of energy such as gas can be used with the dryer of this invention.

Whereas embodiments of the invention described herein utilise periods of varying heater energy, the invention can also be practised using a constant heating energy level or in some cases no heating energy.

It is also envisaged that the dryer of this invention can utilise energy from more than one source, for example waste heat from a refrigerator or air conditioner, or solar energy. Furthermore, intelligence can be applied to the use of different energy sources, so that, for example, if solar energy is being used, priority can be given to that source over say mains electricity when solar power is available.

Some embodiments can also utilise a variable-speed fan, so that airflow can be optimised for the desired drying profile.

It will also be understood that the invention is not limited to tumble dryers and can be applied to other dryers, such as combination washer/dryers or cabinet dryers, with good results. Similarly, the invention can be applied to dryers used for drying things other than clothes.

Additional features can also be included to indicate the estimated or actual energy consumption. It is also anticipated that the invention can be adapted to allow the user to select the amount of energy to be consumed, as well as or instead of the maximum drying time. For example, control panel 1 could include a button marked “Eco”, “Power saver” or the like, which would have the effect of instructing the invention to adopt a least-power drying algorithm rather than a fast drying algorithm.

The invention can also include features well known in the art, such as permanent press cycles, periodic reversing to avoid clumping, periodic tumbling after completion of drying to avoid creasing, and so on.

1. A clothes drying energy minimisation method comprising the steps of receiving from an operator a desired drying time and operating a dryer in a manner responsive to said received time.

2. A clothes dryer control method comprising the steps of inputting from an operator a drying-time selection, estimating how much power needs to be applied to heat the air entering the dryer in order to dry the clothes within the input time, and controlling the heating power according to that estimate.

3. A clothes dryer control method according to claim 1 wherein the drying time is input as a duration relative to the start time or as an absolute time of day.

4. A clothes dryer control method according to claim 2 wherein the estimating step of the invention includes at least one of the following sub-steps:
a) Measuring moisture content of the clothes
b) Measuring change in moisture content of the clothes over time
c) Measuring the ambient temperature
d) Measuring the dryer air temperature inside the machine or at the exhaust
e) Measuring change in the dryer exhaust air temperature over time
f) Measuring the humidity within the dryer, at the air intake or at the exhaust
g) Measuring the change in humidity within the dryer, at the air intake or at the exhaust
h) Measuring the mass of the clothes in the drying chamber
i) Measuring change in the mass of the clothes in the drying chamber over time
j) Measuring vibration of the dryer or its components
k) Measuring change in vibration of the dryer or its components over time
l) Factoring into a predictive algorithm the time of day at which the drying cycle is being performed
m) Factoring into a predictive algorithm the time of day at which the drying cycle is being performed so as to consume energy at the time of lowest energy cost
n) Factoring into a predictive algorithm the time of day at which the drying cycle is being performed so as to consume energy at the time of greatest energy availability
o) Factoring into a predictive algorithm the duration of drying selected by the operator
p) Factoring into a predictive algorithm a maximum clothing temperature selected by the operator

5. A clothes dryer control method according to claim 4 in which the step of measuring moisture content is practised by measuring at least one of:
a) the absorption of acoustic waves
b) the absorption of electromagnetic waves
c) the reflection of acoustic waves
d) the reflection of electromagnetic waves
e) the change in absorption of acoustic waves
f) the change in absorption of electromagnetic waves
g) the change in reflection of acoustic waves
h) the change in reflection of electromagnetic waves
by the contents of the drying chamber.

6. A clothes dryer control method according to claim 1 including the step of varying the air flow through the drying clothes according to an adaptive algorithm.

7. A clothes dryer control method according to claim 2 including the further steps of increasing the airflow when no or little heating is being used and decreasing the air flow when significant heating of the clothes is required.

8. A clothes dryer control method according to claim 1 including the steps of exposing wet clothes to a low temperature air flow for a first time interval followed by a higher temperature air flow for a second time interval.

9. A clothes dryer control method according to claim 1 including the further step of exposing the clothes to a low temperature air flow to cool the clothes after drying.

10. A clothes dryer control method according to claim 1 further comprising the steps of referring to a schedule of energy tariffs and minimising cost of energy by scheduling the consumption of energy according to the times of day at which energy is least expensive.

11. An energy-saving clothes dryer comprising means for receiving from an operator a desired drying time and controller means adapted to operate a dryer in a manner responsive to said received time.

12. An energy-saving clothes dryer comprising means for receiving from an operator a desired drying time and controller means adapted to estimate how much power needs to be applied to heat the air entering the dryer in order to dry the clothes within the input time, and controlling the heating power according to that estimate.

13. An energy-saving clothes dryer according to claim 12 wherein the controller means of the invention includes means for at least one of the following:
a) Measuring moisture content of the clothes
b) Measuring change in moisture content of the clothes over time
c) Measuring the ambient temperature
d) Measuring the dryer air temperature inside the machine or at the exhaust
e) Measuring change in the dryer exhaust air temperature over time
f) Measuring the humidity within the dryer, at the air intake or at the exhaust
g) Measuring the change in humidity within the dryer, at the air intake or at the exhaust
h) Measuring the mass of the clothes in the drying chamber
i) Measuring change in the mass of the clothes in the drying chamber over time
j) Measuring vibration of the dryer or its components
k) Measuring change in vibration of the dryer or its components over time
l) Factoring into a predictive algorithm the time of day at which the drying cycle is being performed
m)Factoring into a predictive algorithm the time of day at which the drying cycle is being performed so as to consume energy at the time of lowest energy cost
n) Factoring into a predictive algorithm the time of day at which the drying cycle is being performed so as to consume energy at the time of greatest energy availability
o) Factoring into a predictive algorithm the duration of drying selected by the operator
p) Factoring into a predictive algorithm a maximum clothing temperature selected by the operator

14. An energy-saving clothes dryer according to claim 13 wherein the means for measuring moisture content is adapted to measure:
a) the absorption of acoustic waves
b) the absorption of or electromagnetic waves
c) the reflection of acoustic waves
d) the reflection of electromagnetic waves
e) the change in absorption of acoustic waves
f) the change in absorption of electromagnetic waves
g) the change in reflection of acoustic waves
h) the change in reflection of electromagnetic waves
by the contents of the drying chamber

15. An energy-saving clothes dryer according to claim 11 including means for varying the air flow through the drying clothes according to an adaptive algorithm.

16. An energy-saving clothes dryer according to claim 11 including means for increasing the airflow when no or little heating is being used and decreasing the air flow when significant heating of the clothes is required.

17. An energy-saving clothes dryer according to claim 11 wherein said controller is adapted to expose wet clothes to a low temperature air flow for a first time interval followed by a higher temperature air flow for a second time interval.

18. An energy-saving clothes dryer according to claim 11 wherein said controller is further adapted to expose the clothes to a low temperature air flow to cool the clothes after drying.

19. An energy-saving clothes dryer according to claim 11 wherein said controller is further adapted to refer to a schedule of energy tariffs and minimise cost of energy by scheduling the consumption of energy according to the times of day at which energy is least expensive.

20. An energy-saving clothes dryer according to claim 11 wherein heating energy is sourced from at least one of
a) Electricity
b) Gas
c) Space heating
d) Refrigerator
e) Air conditioner
f) Ambient air
g) Hot water
h) Steam
i) Waste heat
j) Solar energy
